(19) United States
(12) Patent Application Publication
(10) Pub. No.: US 2026/0232020 A1
(43) Pub. Date: Aug. 13, 2026

(54) CARTRIDGE WITH INCLINED WALL

(71) Applicant: Philip Morris Products S.A., Neuchatel (CH)

(72) Inventors: Farhang MOHSENI, Neuchâtel (CH); Catalin Marian CHISCOP, Murten (CH)

(73) Assignee: Philip Morris Products S.A., Neuchatel (CH)

(21) Appl. No.: 19/155,977

(22) PCT Filed: Feb. 13, 2024
(86) PCT No.: PCT/EP2024/053603

§ 371 Date: Aug. 13, 2025

(30) Foreign Application Priority Data
Feb. 20, 2023 (EP) 23157607.5

(51) Int. Cl. A24F 40/42; A24F 40/10; A24F 40/44; A24F 40/465; A24F 40/485; A24F 40/51

(52) U.S. Cl. CPC A24F 40/42; A24F 40/10; A24F 40/44; A24F 40/465; A24F 40/485; A24F 40/51

(57) ABSTRACT

A cartridge for an aerosol-generating device is provided, including: an inner airflow channel extending between proximal and distal ends of the cartridge along a longitudinal central axis of the cartridge; a proximal portion of the cartridge including a liquid storage portion to store a liquid aerosol-forming substrate; and a distal portion of the cartridge including an outer wall, a liquid supply channel, and an internal separating wall, the supply channel being in fluid communication with the storage portion, the separating wall being arranged between the supply channel and a distal portion of the inner airflow channel, the distal portion of the cartridge being surrounded by the outer wall, a region of the outer wall surrounding a distal part of the supply channel including an inclined wall portion of the outer wall so the distal part of the supply channel is narrower than a proximal part of the supply channel.

The present disclosure relates to a cartridge for use with an aerosol-generating device. The present disclosure further relates to an aerosol-generating system comprising the cartridge and the aerosol-generating device.

It is known to provide an aerosol-generating device for generating an inhalable vapor. Such devices may heat an aerosol-forming substrate contained in a cartridge without burning the aerosol-forming substrate. The aerosol-generating device may comprise a heating arrangement. The heating arrangement may be an induction heating arrangement and may comprise an inductor coil and a susceptor. The susceptor may be part of the device or may be part of the cartridge.

Upon heating to a target temperature, the aerosol-forming substrate vaporises to form an aerosol. The aerosol-forming substrate may be present in solid form or in liquid form. Liquid aerosol-forming substrate may be comprised in a liquid storage portion and may be delivered to the heating element via a capillary component.

It would be desirable to provide an aerosol-generating system with an improved energy efficiency. It would be desirable to provide an aerosol-generating system which allows to quickly heat a heating element to a target temperature.

It would be desirable to provide a cartridge with a more efficient supply of liquid aerosol-forming substrate from a liquid storage portion towards the heating element. It would be desirable to provide a cartridge with improved aerosolization of the aerosol-forming substrate.

It would be desirable to provide a cartridge with reduced space requirements of an inner airflow channel and an inner liquid supply channel. It would be desirable to provide a cartridge with a reduced size. It would be desirable to provide a cartridge with a reduced outer diameter. It would be desirable to provide a cartridge with a reduced outer diameter of a distal portion of the cartridge such that the outer diameter is similar to an outer diameter of a heat-not-burn aerosol-generating article. It would be desirable to provide a cartridge which can be used in a universal aerosol-generating device which allows to heat both cartridges with liquid aerosol-forming substrates and heat-not-burn aerosol-generating articles with solid aerosol-forming substrates.

It would be desirable to provide a cartridge for an aerosol-generating device which can be more efficiently heated.

According to an embodiment of the invention there is provided a cartridge for use with an aerosol-generating device. The cartridge may comprise an inner airflow channel extending between a proximal end and a distal end of the cartridge along a longitudinal central axis of the cartridge. The cartridge may comprise a proximal portion of the cartridge comprising a liquid storage portion for storing a liquid aerosol-forming substrate. The cartridge may comprise a distal portion of the cartridge. The distal portion of the cartridge may comprise an outer wall. The distal portion of the cartridge may comprise a liquid supply channel. The distal portion of the cartridge may comprise an internal separating wall. The liquid supply channel may be in fluid communication with the liquid storage portion. The separating wall may be arranged between the liquid supply channel and a distal portion of the inner airflow channel. The distal portion of the cartridge may be surrounded by the outer wall. A region of the outer wall surrounding a distal part of the liquid supply channel may comprise an inclined wall portion such that the distal part of the liquid supply channel is narrower than a proximal part of the liquid supply channel. A distal part of the separating wall may comprise a fluid permeable portion to fluidly connect the narrower distal part of the liquid supply channel with the distal portion of the inner airflow channel.

According to an embodiment of the invention there is provided a cartridge for use with an aerosol-generating device. The cartridge comprises an inner airflow channel extending between a proximal end and a distal end of the cartridge along a longitudinal central axis of the cartridge. The cartridge comprises a proximal portion of the cartridge. The proximal portion of the cartridge comprises a liquid storage portion for storing a liquid aerosol-forming substrate. The cartridge comprises a distal portion of the cartridge. The distal portion of the cartridge comprises an outer wall, a liquid supply channel and an internal separating wall. The liquid supply channel is in fluid communication with the liquid storage portion. The separating wall is arranged between the liquid supply channel and a distal portion of the inner airflow channel. The distal portion of the cartridge is surrounded by the outer wall. A region of the outer wall surrounding a distal part of the liquid supply channel comprises an inclined wall portion such that the distal part of the liquid supply channel is narrower than a proximal part of the liquid supply channel. A distal part of the separating wall comprises a fluid permeable portion to fluidly connect the narrower distal part of the liquid supply channel with the distal portion of the inner airflow channel.

An aerosol-generating system with an improved energy efficiency may be provided. An aerosol-generating system which allows to quickly heat a heating element to a target temperature may be provided. A cartridge with a more efficient supply of liquid aerosol-forming substrate from a liquid storage portion towards the heating element may be provided. A cartridge with improved aerosolization of the aerosol-forming substrate may be provided. A cartridge with reduced space requirements of an inner airflow channel and an inner liquid supply channel may be provided. A cartridge with a reduced size may be provided. A cartridge with a reduced outer diameter may be provided. A cartridge with a reduced outer diameter of a distal portion of the cartridge may be provided, such that the outer diameter of the cartridge may be similar to an outer diameter of a heat-not-burn aerosol-generating article. A cartridge which can be used in a universal aerosol-generating device which allows to heat both cartridges with liquid aerosol-forming substrates and heat-not-burn aerosol-generating articles with solid aerosol-forming substrates may be provided. A cartridge for an aerosol-generating device which can be more efficiently heated may be provided.

By the cartridge comprising the distal portion with the outer wall and the separating wall, a cartridge that comprises a liquid supply channel and a distal portion of an inner airflow channel with a less complex construction may be provided. No further tubes or wall elements to achieve the separate channels are required. Production costs may be reduced. A cartridge with reduced space requirements of the distal portion may be provided.

Due to the reduced space requirements, a cartridge with a reduced outer diameter of the distal portion may be provided. The reduced diameter may be similar in size to the outer diameter of an aerosol-generating article. For example, a typical outer diameter of a heat-not-burn article may be about 7 millimeters. A cartridge may be provided that can be used in a universal aerosol-generating system with an aerosol generating device comprising a cavity that may receive both an aerosol-generating article or a cartridge.

A reduced outer diameter of the cartridge may allow for a smaller diameter of an inductor coil of the aerosol-generating device. Less thermal losses and better inductive coupling may be provided. A more efficient aerosol-generating system may be provided.

Due to the reduced space requirements for additional tubes or wall elements, more space for the liquid supply channel and the inner airflow channel may be available. Cross-sections of one or both of the liquid supply channel and the inner airflow channel may be enlarged. A more efficient aerosol-generating system may be provided.

By the cartridge comprising the inclined wall portion of the outer wall, liquid supply to the fluid permeable portion of the separating wall may be facilitated. The inclined wall portion may guide the liquid aerosol-forming substrate towards the fluid permeable portion of the separating wall, where the liquid may be evaporated by the heater assembly. The formation of dead zones for the liquid may be reduced. The supply of liquid aerosol-forming substrate may be optimized. A more efficient aerosol-generating system may be provided.

A user may regularly hold an aerosol-generating system comprising the cartridge in an upright position with the distal end pointing towards the center of gravity. The inclined wall portion may thus facilitate complete depletion of the liquid aerosol-forming reservoir when the cartridge is almost empty. A more efficient aerosol-generating system may be provided.

The distal part of the liquid supply channel being narrower than a proximal part of the liquid supply channel may mean that the inclined wall portion is inclined with respect to the longitudinal central axis such that the cross-section of the liquid supply channel tapers in a direction towards the distal end of the cartridge. The distal part of the liquid supply channel being narrower than a proximal part of the liquid supply channel may mean that the cross-sectional area of the liquid supply channel shrinks in a direction towards the distal end of the cartridge.

The inclined wall portion may be located adjacent the liquid supply channel, such that the liquid supply channel is arranged along the transverse direction between the inclined wall portion and the separating wall. The inclined wall portion may be inclined with respect to the longitudinal central axis such that a cross-section of the liquid supply channel tapers in a direction parallel to the longitudinal central axis.

The separating wall may be arranged along a transverse direction between the liquid supply channel and the distal portion of the inner airflow channel. The outer wall of the distal portion of the cartridge may surround both the distal portion of the inner airflow channel, the liquid supply channel, and the separating wall.

As used herein, the term “transverse direction” refers to a direction perpendicular to the longitudinal central axis.

The liquid supply channel may be configured for supplying liquid from the liquid storage portion. The liquid supply channel may be configured for supplying liquid from the liquid storage portion towards the fluid permeable portion of the separating wall.

The outer wall of the distal portion of the cartridge may be substantially tubular. The outer wall may be arranged coaxially around the longitudinal central axis.

The inclined outer wall portion may be configured such that the outer wall tapers towards the distal end of the cartridge. The inclined outer wall portion may be configured such that the outer shape of the cartridge tapers towards the distal end of the cartridge. By the tapering of the cartridge, a cartridge with a reduced size may be provided. By the tapering of the cartridge, a cartridge with a reduced outer diameter of a distal portion of the cartridge may be provided.

The fluid permeable portion of the separating wall may extend up to a distal end of the liquid supply channel in a direction in parallel to the longitudinal central axis of the cartridge. The inclined wall portion of the outer wall may extend up to the distal end of the liquid supply channel longitudinal central axis of the cartridge.

The inclined wall portion may be substantially planar.

An acute angle between the longitudinal central axis and a normal to the inclined planar wall portion may be between 45 degrees and 85 degrees, preferably between 50 degrees and 80 degrees, more preferably between 60 degrees and 80 degrees, more preferably between 60 degrees and 75 degrees, more preferably between 65 degrees and 72 degrees, more preferably between 66 degrees and 70 degrees.

As used herein, the term “substantially planar” refers to a three-dimensional object having two opposing planar major boundary surfaces defining a length and a width of the object. A thickness of the object is substantially less than a length and a width of the object. For example, a thickness of the object may be a fifth or less than each a length and a width of the object. Slight curvatures of one or both of the generally planar major boundary surfaces may be allowable. Also, small protrusions extending perpendicular from a major boundary surface, for example side legs or bent end portions, may be allowable, as long as the overall extension in the length and width dimensions substantially exceeds the thickness of the object.

In that context, the term “a normal to a planar object” refers to a line or direction being perpendicular to the planar major boundary surfaces of the object.

The fluid permeable portion of the separating wall may comprise a wick element. The liquid supply channel may be configured for supplying liquid from the liquid storage portion to the wick element.

The wick element may be arranged on a first side of the separating wall facing the liquid supply channel. The wick element may comprise one or more of a cotton-based material, a porous ceramic-based material, and a porous graphite-based material. The wick element may be substantially planar.

The distal portion of the cartridge may comprise a heater assembly for heating the liquid aerosol-forming substrate.

The wick element may form part of the heater assembly. The liquid supply channel may be configured for supplying liquid from the liquid storage portion to the heater assembly. The heater assembly may comprise a susceptor element for heating the liquid aerosol-forming substrate. The susceptor element may be arranged on a second side of the separating wall facing the distal portion of the inner airflow channel. The susceptor element may be substantially planar. The susceptor element may be arranged substantially in parallel to the longitudinal central axis.

The wick element may be arranged to transfer liquid aerosol-forming substrate from the liquid supply channel to the susceptor element.

The wick element may form part of the fluid permeable portion of the separating wall. The susceptor element may form part of the fluid permeable portion of the separating wall. The heater assembly may form part of the fluid permeable portion of the separating wall.

Both the inclined wall portion and the heater assembly may be substantially planar. A dihedral angle between the planar inclined wall portion and the planar heater assembly may be between 5 degrees and 40 degrees, preferably between 10 degrees and 35 degrees, more preferably between 15 degrees and 30 degrees, more preferably between 18 degrees and 26 degrees, more preferably between 20 degrees and 24 degrees. A dihedral angle between the planar inclined wall portion and the planar heater assembly may be about 22 degrees.

The separating wall may be substantially planar. The separating wall and the susceptor element may be substantially co-planar. The separating wall and the heater assembly may be substantially co-planar.

An angle between a normal to the separating wall and the longitudinal central axis may be between 75 degrees and 105 degrees, preferably between 80 degrees and 100 degrees, more preferably between 85 degrees and 95 degrees. An angle between a normal to the separating wall and the longitudinal central axis may be about 90 degrees. The separating wall may extend substantially in parallel to the longitudinal central axis of the cartridge.

At least a portion of the susceptor element may be fluid permeable. The fluid permeability of the susceptor element may be provided by means of one or more apertures or perforations in the susceptor element. For example, the susceptor element may be formed from a metal sheet which is provided with a plurality of apertures.

The fluid permeability of the susceptor element may be provided by means of an intrinsic porosity of the material used for the susceptor element. The susceptor element may comprise or may consist of a porous material. For example, the porous material may be a porous ceramic or a porous carbon-based material. The porous material may be a foamed metal.

The susceptor element may comprise one or both of a metal and an alloy. The susceptor element may comprise a ferromagnetic alloy material. The ferromagnetic alloy material may be perforated to provide a desired porosity. The alloy material may be a ferromagnetic inox alloy.

The susceptor element may comprise one or more of a ferromagnetic stainless-steel alloy, a magnetic carbon-based material, and a carbon-based compound with metal structural dispersion.

The ferromagnetic stainless-steel alloy may comprise one or more of 304 stainless steel and 410 stainless steel. The magnetic carbon-based material may comprise one or more of irradiated graphite, nanocarbons, fullerenes, oxygen-containing carbons, and graphene with point defects. The carbon-based compound with metal structural dispersion may comprise a Fe₃O₄-graphitized carbon black (mGCB) composite.

The wick element may be provided adjacent to at least a portion of the susceptor element. At least a portion of the wick element may be fluid permeable. The wick element may have a substantially planar shape. The wick element may contact at least a portion of the susceptor element. A major planar surface of the wick element may contact a major planar surface of the susceptor element.

The wick element may comprise a ceramic material. The ceramic material may be porous. The ceramic material may be porous silica ceramics. The wick element may comprise one or more of a cotton-based material, a porous ceramic-based material, a porous graphite-based material, and a glass fiber sheet material.

The wick element may comprise a porous material and the susceptor element may comprise a porous material. The porosity of the susceptor element may be at least the same range as the porosity of the wick element The porosity of the porous material of the susceptor element may be higher than the porosity of the porous material of the wick element.

As used herein, the term ‘porosity’ is defined as the percentage of a unit volume which is void of material. The porosity may be derived using standard method and equation giving a decimal value for porosity. Knowing the pore volume of a defined volume of material (Vp) and its total volume (Vt), porosity (Pt) is given by the ratio Vp/Vt. To express porosity as a percent, that decimal is simply multiplied by 100%. For example, Pt=0.51, therefore 0.51×100%=51%.

Better aerosolization results may be provided when the porosity of the porous material of the susceptor element is higher than the porosity of the porous material of the wick element. The porosity of the susceptor element may be of about 25 to 80%, preferably of about 55 to 75%, most preferably of about 65 to 75%. The porosity of the wick element may be between 10% and 60%, preferably between 35% and 55%, more preferably between 40% and 50%, and may be lower than the porosity of the susceptor element.

The separating wall generally comprises a fluid permeable portion and a non-fluid-permeable portion. The separating wall is configured to separate the liquid supply channel from the distal portion of the inner airflow channel except for the fluid-permeable portion of the separating wall. The separating wall is generally configured to allow fluid communication between the liquid supply channel and the distal portion of the inner airflow channel exclusively via the fluid-permeable portion. The fluid permeable portion of the separating wall may comprise one or more apertures or cut-outs of the separating wall. The fluid permeable portion of the separating wall may comprise a fluid-permeable material, for example a porous material. The fluid permeable portion may comprise the wick element. The fluid permeable portion may comprise the susceptor element. The fluid permeable portion may comprise the heater assembly.

As used herein, the term “inner airflow channel extending between a proximal end and a distal end of the cartridge” means that the inner airflow channel substantially extends between the proximal end and the distal end of the cartridge. For example, the inner airflow channel may extend between a proximal end region and a distal end region of the cartridge.

As used herein, the term “inner airflow channel extending along a longitudinal central axis of the cartridge” refers to the general direction of the inner airflow channel along the longitudinal central axis of the cartridge. It is not required that the inner airflow channel extends exactly at the position of the longitudinal central axis. The inner airflow channel or parts thereof may be arranged offset relative to the longitudinal central axis. Also, it is not required that the inner airflow channel extends along a straight line along the longitudinal central axis. For example, turns of the inner airflow channel are possible.

The susceptor element may form part of the separating wall. The susceptor element may be arranged offset relative to the longitudinal central axis. The susceptor element being arranged offset relative to the longitudinal central axis, may allow for the susceptor element to be located in closer proximity to the windings of an inductor coil of an aerosol-generating device in a use configuration. The inductive coupling between the susceptor element and the inductor coil may be improved. A more efficient aerosol-generating system may be provided.

The susceptor element being arranged offset relative to the longitudinal central axis, may allow for the liquid supply channel and the distal portion of the inner airflow channel to be differently sized. For example, a cross-section of the liquid supply channel may exceed a cross-section of the distal portion of the inner airflow channel in a transverse plane. An enlarged cross-section of the liquid supply channel may improve the liquid supply rate. A reduced cross-section of the distal portion of the inner airflow channel may enhance the airflow velocity in the airflow channel. A reduced cross-section of the distal portion of the inner airflow channel may enhance the airflow velocity in the airflow channel in proximity to the susceptor element. A higher velocity may beneficially increase the cooling rate of the airflow. A higher velocity may improve the droplet distribution in the airflow.

The susceptor element may be arranged offset relative to the longitudinal central axis such that, in a transverse plane perpendicular to the longitudinal central axis, an area of a cross-section of the liquid supply channel being arranged on one side of the susceptor element exceeds an area of a cross-section of the distal portion of the inner airflow channel being arranged on an opposite side of the susceptor element.

The susceptor element may be offset from the longitudinal central axis by between 5 percent and 25 percent, preferably between 10 percent and 20 percent, more preferably between 12 percent and 16 percent, more preferably between 13 percent and 15 percent, of an outer diameter of the outer wall in a transverse direction perpendicular to the longitudinal central axis. The susceptor element may be offset from the longitudinal central axis by between 0.5 millimeters and 2.5 millimeters, preferably between 0.5 millimeters and 2.0 millimeters, more preferably between 0.5 millimeters and 1.5 millimeters, more preferably between 0.7 millimeters and 1.3 millimeters, more preferably between 0.9 millimeters and 1.1 millimeters, in a transverse direction perpendicular to the longitudinal central axis.

The separating wall may be arranged offset relative to the longitudinal central axis. The separating wall may be offset from the longitudinal central axis by between 5 percent and 15 percent of an outer diameter of the outer wall in a transverse direction, the transverse direction being perpendicular to the longitudinal central axis.

The separating wall may be arranged offset relative to the longitudinal central axis such that, in a transverse plane perpendicular to the longitudinal central axis, a cross-sectional area of the liquid supply channel being arranged on one side of the separating wall exceeds a cross-sectional area of the distal portion of the inner airflow channel being arranged on an opposite side of the separating wall. An enlarged cross-section of the liquid supply channel may improve the liquid supply rate. A reduced cross-section of the distal portion of the inner airflow channel may enhance the airflow velocity in the airflow channel. A reduced cross-section of the distal portion of the inner airflow channel may enhance the airflow velocity in the airflow channel in proximity to the susceptor element. A higher velocity may beneficially increase the cooling rate of the airflow. A higher velocity may improve the droplet distribution in the airflow.

The separating wall may be offset from the longitudinal central axis in a transverse direction such that, in the transverse direction, a width of the distal portion of the airflow channel is between 40 percent and 80 percent, preferably between 45 percent and 75 percent, of a width of the liquid supply channel, the transverse direction being perpendicular to the longitudinal central axis.

The separating wall may be offset from the longitudinal central axis in a transverse direction such that, in the transverse direction, a width of the distal portion of the airflow channel is between 40 percent and 60 percent, preferably between 45 percent and 55 percent, of a width of the liquid supply channel, the transverse direction being perpendicular to the longitudinal central axis.

The separating wall may be offset from the longitudinal central axis in a transverse direction such that, in the transverse direction, a width of the distal portion of the airflow channel is between 60 percent and 80 percent, preferably between 65 percent and 75 percent, of a width of the liquid supply channel, the transverse direction being perpendicular to the longitudinal central axis.

The separating wall may be arranged offset relative to the longitudinal central axis such that the total inner volume of the liquid supply channel exceeds the inner volume of the distal portion of the inner airflow channel when measured over the entire length of the liquid supply channel in a direction parallel to the longitudinal central axis.

A center of the separating wall may be offset from the longitudinal central axis by between 5 percent and 15 percent of an outer diameter of the outer wall in the transverse direction. As used herein, the “center of the separating wall” is defined as the middle of the separating wall in the transverse direction.

The heater assembly may be held in position by the separating wall. The heater assembly may be attached to the separating wall. The heater assembly may be attached to the non-fluid permeable portion of the separating wall. The non-fluid permeable portion of the separating wall may comprise a connector element for attachment to the heater assembly. The connector element may comprise a connector strip attached to both a surface of the heater assembly and a surface of the separating wall.

The distal portion of the cartridge may comprise the distal portion of the inner airflow channel. The proximal portion of the cartridge may comprise a proximal portion of the inner airflow channel.

The liquid storage portion may surround a proximal portion of the inner airflow channel. The liquid storage portion may comprise a tubular portion. The liquid storage portion may be tubular. The liquid storage portion may coaxially surround the proximal portion of the inner airflow channel.

The distal portion of the cartridge may have a circular cross-section perpendicular to the longitudinal central axis. The proximal portion of the cartridge may have an oval cross-section perpendicular to the longitudinal central axis. The oval cross-section may taper towards the proximal end in a direction parallel to the longitudinal central axis.

The proximal portion of the cartridge may be configured as a mouthpiece.

The distal portion of the cartridge may be configured for engaging with the aerosol-generating device. The distal portion of the cartridge may be configured for being inserted into a cavity of the aerosol-generating device.

A distal end of the cartridge may comprise connection means. The connection means may be configured to be releasably connectable to an aerosol-generating device.

An outer diameter of the outer wall in a transverse direction may be equal to or less than 10 millimeters, preferably equal to or less than 9.5 millimeters, more preferably equal to or less than 9 millimeters, more preferably equal to or less than 8.5 millimeters, more preferably equal to or less than 8 millimeters, more preferably equal to or less than 7.5 millimeters, more preferably equal to or less than 7.0 millimeters.

A wall thickness of the outer wall may be between 0.2 millimeters and 1.5 millimeters, preferably between 0.5 millimeters and 1.0 millimeters.

The liquid supply channel may comprise an adsorbent material, preferably a cotton based adsorbent material.

According to an embodiment of the invention there is provided a cartridge for use with an aerosol-generating device. The cartridge comprises an inner airflow channel extending between a proximal end and a distal end of the cartridge along a longitudinal central axis of the cartridge. The cartridge comprises a proximal portion of the cartridge. The proximal portion of the cartridge comprises a liquid storage portion for storing a liquid aerosol-forming substrate. The cartridge comprises a distal portion of the cartridge. The distal portion of the cartridge comprises an outer wall, a liquid supply channel and an internal separating wall. The liquid supply channel is in fluid communication with the liquid storage portion. The separating wall is arranged between the liquid supply channel and a distal portion of the inner airflow channel. The distal portion of the cartridge is surrounded by the outer wall. A region of the outer wall surrounding a distal part of the liquid supply channel comprises an inclined wall portion such that the distal part of the liquid supply channel is narrower than a proximal part of the liquid supply channel and such that the distal part of the cartridge tapers towards the distal end. A distal part of the separating wall comprises a fluid permeable portion to fluidly connect the narrower distal part of the liquid supply channel with the distal portion of the inner airflow channel.

According to an embodiment of the invention there is provided an aerosol-generating system, comprising the cartridge as described herein and an aerosol-generating device. The aerosol-generating device may comprise a cavity arranged for receiving at least the distal portion of the cartridge and an inductor coil at least partly surrounding the cavity. The cavity of the aerosol-generating device may be a heating chamber.

The aerosol-generating device may comprise a wall surrounding the cavity. The wall may comprise a recess on an outer surface thereof. The inductor coil may be at least partly received in the recess.

As used herein, the terms ‘tubular’, ‘tubular unit’, ‘tubular component’, ‘tubular element’, and ‘tubular shape’ refer to three-dimensional objects and three-dimensional geometric shapes comprising a bottom basal plane, a top basal plane, and a sidewall circumscribing a hollow interior, the sidewall being arranged between the bottom basal plane and the top basal plane. The sidewall extends along a longitudinal axis of the tubular element between the bottom basal plane and the top basal plane. The longitudinal axis may be perpendicular to one or both of the bottom basal plane and the top basal plane.

A bottom base of the tubular element lies within the bottom basal plane. A top base of the tubular element lies within the top basal plane. A cross-sectional shape of one or both of the bottom and top bases may be circular. A cross-sectional shape of one or both of the bottom and top bases may be non-circular, for example elliptic, stadium-shaped, or rectangular. One or both of the bottom base and the top base may be at least partly open to provide an internal hollow passage of the tubular element.

The tubular element may have the shape of a right circular hollow cylinder. The tubular element may have the shape of a non-circular hollow cylinder, for example an elliptic hollow cylinder, or a stadium-shaped hollow cylinder. The tubular element may have the shape of a hollow cuboid.

The longitudinal axis of the tubular element may be arranged in parallel to the longitudinal axis of the cartridge. A longitudinal central axis of the tubular element may coincide with a longitudinal central axis of the cartridge.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in liquid form. The terms ‘aerosol’and ‘vapor’are used synonymously.

The aerosol-forming substrate may be part of a cartridge. The aerosol-forming substrate may be part of the liquid held in the liquid storage portion of the cartridge. The liquid storage portion may contain a liquid aerosol-forming substrate.

Preferably, a liquid nicotine or flavor/flavorant containing aerosol-forming substrate may be employed in the liquid storage portion of the cartridge.

The aerosol-forming substrate may comprise nicotine.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the device. Suitable aerosol-formers are well known in the art and include, but are not limited to: polyhydric alcohols, such as triethylene glycol, 1, 3 -butanediol and glycerine; esters of polyhydric alcohols, such as glycerol mono-, di-or triacetate; and aliphatic esters of mono-, di-or polycarboxylic acids, such as dimethyl dodecanedioate and dimethyl tetradecanedioate. Preferred aerosol formers are polyhydric alcohols or mixtures thereof, such as triethylene glycol, 1, 3-butanediol. Preferably, the aerosol former is glycerine.

As used herein, the term ‘cartridge’ refers to an article comprising an aerosol-forming substrate that is capable of releasing volatile compounds that can form an aerosol. For example, a cartridge may be an article that generates an aerosol that is directly inhalable by the user drawing or puffing on a mouthpiece at a proximal or user-end of the device or at a mouthpiece of the cartridge itself. A cartridge may be disposable. A cartridge may be reusable. A cartridge may be refillable. The cartridge may be insertable into a cavity of the aerosol-generating device.

As used herein, the term ‘liquid storage portion’ refer to a storage portion comprising an aerosol-forming substrate that is capable of releasing volatile compounds that can form an aerosol. The liquid storage portion may be configured as a container or a reservoir for storing the liquid aerosol-forming substrate.

The liquid storage portion may be configured as a replaceable tank or container. The liquid storage portion may be any suitable shape and size. For example, the liquid storage portion may be substantially cylindrical. The cross-section of the liquid storage portion may, for example, be substantially circular, elliptical, square or rectangular. The liquid storage portion may form part of the cartridge.

As used herein, the term ‘aerosol-generating device’ refers to a device that interacts with one or both of an aerosol-generating article and a cartridge to generate an aerosol.

As used herein, the term ‘aerosol-generating system’ refers to the combination of an aerosol-generating device with one or both of a cartridge and an aerosol-generating article. In the system, the aerosol-generating device and one or both of the aerosol-generating article and the cartridge cooperate to generate a respirable aerosol.

Preferably, the aerosol-generating device is portable. The aerosol-generating device may have a size comparable to a conventional cigar or cigarette. The device may be an electrically operated smoking device. The device may be a handheld aerosol-generating device. The aerosol-generating device may have a total length between 30 millimeters and 150 millimeters. The aerosol-generating device may have an external diameter between 5 millimeters and 30 millimeters.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise at least one air inlet. The housing may comprise more than one air inlet.

The aerosol-generating device may comprise a heating element. The heating element may comprise at least one inductor coil for inductively heating one or more susceptors.

Operation of the heating element may be triggered by a puff detection system. Alternatively, the heating element may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through the airflow path of the aerosol-generating device per time by the user. The initiation of the puff may be detected by the airflow sensor when the airflow exceeds a predetermined threshold. Initiation may also be detected upon a user activating a button. The sensor may also be configured as a pressure sensor.

The aerosol-generating device may include a user interface to activate the aerosol-generating device, for example a button to initiate heating of the aerosol-generating device or a display to indicate a state of the aerosol-generating device or of the aerosol-forming substrate.

The aerosol-generating device may include additional components, such as, for example a charging unit for recharging an on-board electric power supply in an electrically operated or electric aerosol-generating device.

As used herein, the term ‘proximal’ refers to a user-end, or mouth-end of the cartridge, the aerosol-generating device or system or a part or portion thereof, and the term ‘distal’ refers to the end opposite to the proximal end. When referring to the cavity or heating chamber, the term ‘proximal’ refers to the region closest to the open end of the cavity and the term ‘distal’refers to the region closest to the closed end.

As used herein, the terms ‘upstream’ and ‘downstream’ are used to describe the relative positions of components, or portions of components, of the cartridge or the aerosol-generating device in relation to the direction in which a user draws on the aerosol-generating device during use thereof.

The term ‘airflow path’ as used herein denotes a channel suitable to transport gaseous media. An airflow path may be used to transport ambient air. An airflow path may be used to transport an aerosol. An airflow path may be used to transport a mixture of air and aerosol.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating device or cartridge. In this manner, the aerosol-forming substrate is heated by the susceptor such that an aerosol is formed.

The susceptor material may be any material that can be inductively heated to a temperature sufficient to aerosolize an aerosol-forming substrate. The following examples and features concerning the susceptor may apply to one or both of the susceptor element of the cartridge, a susceptor of an aerosol-generating device, and a susceptor of an aerosol-generating article. Suitable materials for the susceptor material include graphite, molybdenum, silicon carbide, stainless steels, niobium, aluminium, nickel, nickel containing compounds, titanium, and composites of metallic materials. Preferred susceptor materials comprise a metal or carbon. Advantageously the susceptor material may comprise or consists of a ferromagnetic or ferri-magnetic material, for example, ferritic iron, a ferromagnetic alloy, such as ferromagnetic steel or stainless steel, ferromagnetic particles, and ferrite. A suitable susceptor material may be, or comprise, aluminium. The susceptor material may comprise more than 5 percent, preferably more than 20 percent, more preferably more than 50 percent, or more than 90 percent of ferromagnetic, ferri-magnetic or paramagnetic materials. Preferred susceptor materials may be heated to a temperature in excess of 250 degrees Celsius without degradation.

The susceptor material may be formed from a single material layer. The single material layer may be a steel layer.

The susceptor material may comprise a non-metallic core with a metal layer disposed on the non-metallic core. The non-metallic core may be fluid permeable. The non-metallic core may be porous. For example, the susceptor material may comprise metallic tracks formed on an outer surface of a ceramic core or substrate. The ceramic core or substrate may be fluid permeable. The ceramic core or substrate may be porous.

The susceptor material may be formed from a layer of austenitic steel. One or more layers of stainless steel may be arranged on the layer of austenitic steel. For example, the susceptor material may be formed from a layer of austenitic steel having a layer of stainless steel on each of its upper and lower surfaces. The susceptor element may comprise a single susceptor material. The susceptor element may comprise a first susceptor material and a second susceptor material. The first susceptor material may be disposed in intimate physical contact with the second susceptor material. The first and second susceptor materials may be in intimate contact to form a unitary susceptor. In certain embodiments, the first susceptor material is stainless steel and the second susceptor material is nickel. The susceptor element may have a two-layer construction. The susceptor element may be formed from a stainless steel layer and a nickel layer.

Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding.

The aerosol-generating device may comprise a power supply for powering the heating element. The power supply may comprise a battery. The power supply may be a lithium-ion battery. Alternatively, the power supply may be a nickel-metal hydride battery, a nickel cadmium battery, or a lithium-based battery, for example a lithium-cobalt, a lithium-iron-phosphate, lithium titanate or a lithium-polymer battery. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The power supply may be a direct current (DC) power supply. In one embodiment, the power supply is a DC power supply having a DC supply voltage in the range of 2.5 Volts to 4.5 Volts and a DC supply current in the range of 1 Amp to 10 Amps (corresponding to a DC power supply in the range of 2.5 Watts to 45 Watts). The aerosol-generating device may advantageously comprise a direct current to alternating current (DC/AC) inverter for converting a DC current supplied by the DC power supply to an alternating current. The DC/AC converter may comprise a Class-D, Class-C or Class-E power amplifier. The AC power output of the DC/AC converter is supplied to the inductor coil.

The power supply may be adapted to power an inductor coil and may be configured to operate at high frequency. A Class-E power amplifier is preferable for operating at high frequency. As used herein, the term ‘high frequency oscillating current’ means an oscillating current having a frequency of between 500 kilohertz and 30 megahertz. The high frequency oscillating current may have a frequency of from 1 megahertz to 30 megahertz, preferably from 1 megahertz to 10 megahertz, and more preferably from 5 megahertz to 8 megahertz.

In another embodiment the switching frequency of the power amplifier may be in the lower kHz range, e.g. between 100 kHz and 400 KHz. In the embodiments, where a Class-D or Class-C power amplifier is used, switching frequencies in the lower kHz range are particularly advantageous.

The aerosol-generating device may comprise a controller. The controller may be electrically connected to the inductor coil. The controller may be electrically connected to the first inductor coil and to the second inductor coil. The controller may be configured to control the electrical current supplied to the inductor coil(s), and thus the magnetic field strength generated by the inductor coil(s).

The power supply and the controller may be connected to the inductor coil(s).

The controller may be configured to be able to chop the current supply on the input side of the DC/AC converter. This way the power supplied to the inductor coil(s) may be controlled by conventional methods of duty-cycle management.

Below, there is provided a non-exhaustive list of non-limiting examples. Any one or more of the features of these examples may be combined with any one or more features of another example, embodiment, or aspect described herein.

Example E1: A cartridge for use with an aerosol-generating device, the cartridge comprising:
an inner airflow channel extending between a proximal end and a distal end of the cartridge along a longitudinal central axis of the cartridge;
a proximal portion of the cartridge comprising a liquid storage portion for storing a liquid aerosol-forming substrate; and
a distal portion of the cartridge comprising an outer wall, a liquid supply channel and an internal separating wall, the liquid supply channel being in fluid communication with the liquid storage portion, the separating wall being arranged between the liquid supply channel and a distal portion of the inner airflow channel, wherein the distal portion of the cartridge is surrounded by the outer wall,
wherein a region of the outer wall surrounding a distal part of the liquid supply channel comprises an inclined wall portion such that the distal part of the liquid supply channel is narrower than a proximal part of the liquid supply channel, and
wherein a distal part of the separating wall comprises a fluid permeable portion to fluidly connect the narrower distal part of the liquid supply channel with the distal portion of the inner airflow channel.

Example E2: The cartridge according to Example E1, wherein the fluid permeable portion of the separating wall extends up to a distal end of the liquid supply channel, and
wherein the inclined wall portion of the outer wall extends up to the distal end of the liquid supply channel.

Example E3: The cartridge according to Example E1 or Example E2, wherein the inclined wall portion is substantially planar.

Example E4: The cartridge according to Example E3, wherein an angle between the longitudinal central axis and a normal to the planar inclined wall portion is between 45 degrees and 85 degrees, preferably between 50 degrees and 80 degrees, more preferably between 60 degrees and 80 degrees, more preferably between 60 degrees and 75 degrees, more preferably between 65 degrees and 72 degrees, more preferably between 66 degrees and 70 degrees.

Example E5: The cartridge according to any of the preceding examples, wherein the liquid storage portion surrounds a proximal portion of the inner airflow channel, preferably wherein the liquid storage portion comprises a tubular portion, more preferably wherein the liquid storage portion is tubular.

Example E6: The cartridge according to any of the preceding examples, wherein the proximal portion of the cartridge is configured as a mouthpiece.

Example E7: The cartridge according to any of the preceding examples, wherein the separating wall is substantially planar.

Example E8: The cartridge according to Example E7, wherein an angle between a normal to the separating wall and the longitudinal central axis is between 75 degrees and 105 degrees, preferably between 80 degrees and 100 degrees, more preferably between 85 degrees and 95 degrees.

Example E9: The cartridge according to Example E8, wherein the separating wall extends substantially in parallel to the longitudinal central axis of the cartridge.

Example E10: The cartridge according to any of the preceding examples, wherein the fluid permeable portion of the separating wall comprises a wick element, and wherein the liquid supply channel is configured for supplying liquid from the liquid storage portion to the wick element.

Example E11: The cartridge according to Example E10, wherein the wick element is arranged on a first side of the separating wall facing the liquid supply channel.

Example E12: The cartridge according to Example E10 or Example E11, wherein the wick element comprises one or more of a cotton-based material, a porous ceramic-based material, and a porous graphite-based material.

Example E13: The cartridge according to any of Examples E10 to E12, wherein the distal portion of the cartridge comprises a heater assembly for heating the liquid aerosol-forming substrate, wherein the wick element of the fluid permeable portion of the separating wall forms part of the heater assembly, and wherein the liquid supply channel is configured for supplying liquid from the liquid storage portion to the heater assembly.

Example E14: The cartridge according to Example E13, wherein the heater assembly comprises a susceptor element for heating the liquid aerosol-forming substrate, preferably, wherein the susceptor element is arranged on a second side of the separating wall facing the distal portion of the inner airflow channel.

Example E15: The cartridge according to Example E14, wherein the wick element is arranged to transfer liquid aerosol-forming substrate from the liquid supply channel to the susceptor element.

Example E16: The cartridge according to any of Examples E13 to E15, wherein the inclined wall portion is substantially planar, wherein the heater assembly is substantially planar, and wherein a dihedral angle between the planar inclined wall portion and the planar heater assembly is between 5 degrees and 40 degrees, preferably between 10 degrees and 35 degrees, more preferably between 15 degrees and 30 degrees, more preferably between 18 degrees and 26 degrees, more preferably between 20 degrees and 24 degrees, more preferably is about 22 degrees.

Example E17: The cartridge according to any of the preceding examples, wherein the distal portion of the cartridge has a circular cross-section, and the proximal portion of the cartridge has an oval cross-section, preferably, wherein the oval cross-section tapers towards the proximal end.

Example E18: The cartridge according to any of the preceding examples, wherein the distal portion of the cartridge is configured for engaging with the aerosol-generating device, preferably, wherein the distal portion of the cartridge is configured for being inserted into a cavity of the aerosol-generating device.

Example E19: The cartridge according to any of the preceding examples, wherein a distal end of the cartridge comprises connection means configured to be releasably connectable to an aerosol-generating device.

Example E20: The cartridge according to any of the preceding examples, wherein an outer diameter of the outer wall in a transverse direction does not exceed 10 millimeters, preferably does not exceed 9.5 millimeters, more preferably does not exceed 9 millimeters, more preferably does not exceed 8.5 millimeters, more preferably does not exceed 8 millimeters, more preferably does not exceed 7.5 millimeters, more preferably does not exceed 7.0 millimeters, the transverse direction being perpendicular to the longitudinal central axis.

Example E21: The cartridge according to any of the preceding examples, wherein a wall thickness of the outer wall is between 0.2 millimeters and 1.5 millimeters, preferably between 0.5 millimeters and 1.0 millimeters.

Example E22: The cartridge according to any of the preceding examples, wherein the liquid supply channel comprises an adsorbent material, preferably a cotton based adsorbent material.

Example E23: The cartridge according to any of the preceding examples, wherein the outer wall of the distal portion of the cartridge is substantially tubular.

Example E24: An aerosol-generating system, comprising
the cartridge according to any of the preceding examples; and
an aerosol-generating device comprising a cavity arranged for receiving at least the distal portion of the cartridge and an inductor coil at least partly surrounding the cavity.

Features described in relation to one embodiment may equally be applied to other embodiments of the invention.

The invention will be further described, by way of example only, with reference to the accompanying drawings in which:

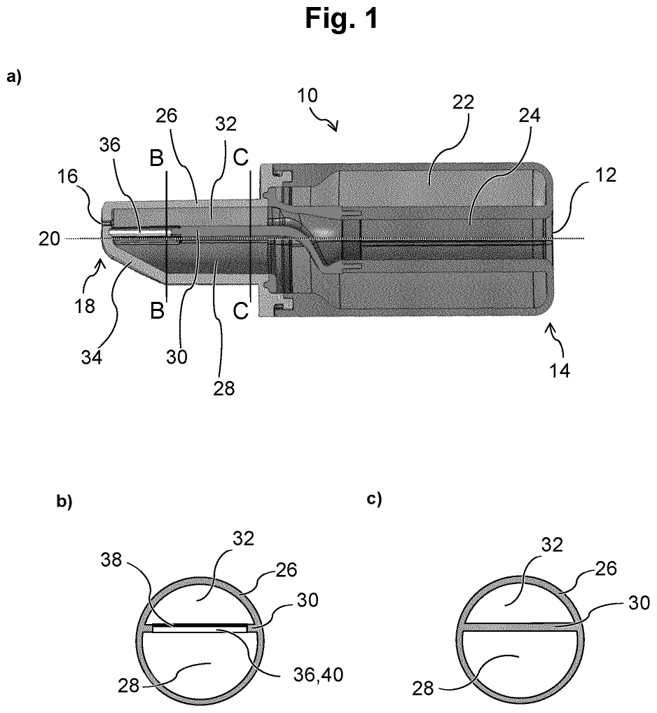

FIGS. 1a to 1c show a cartridge for use with an aerosol-generating device;

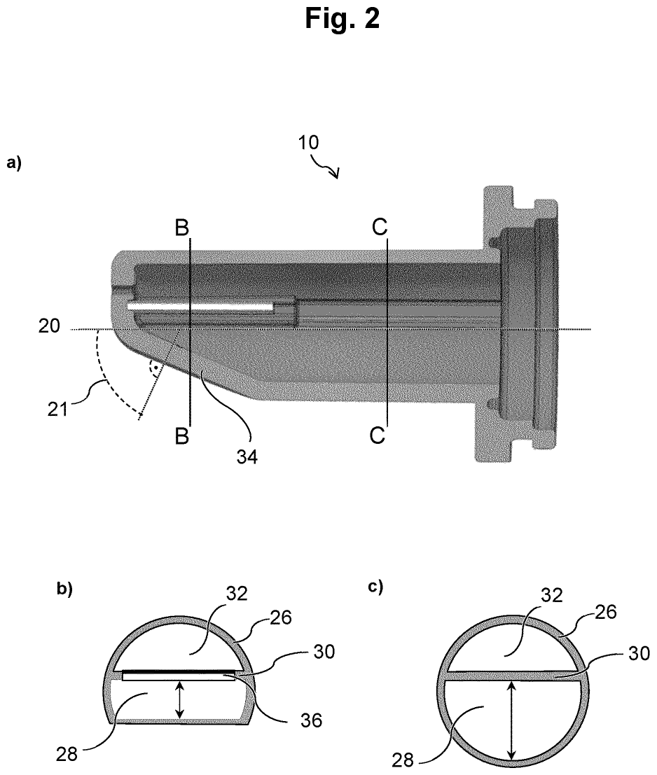

FIGS. 2a to 2c show a cartridge for use with an aerosol-generating device;

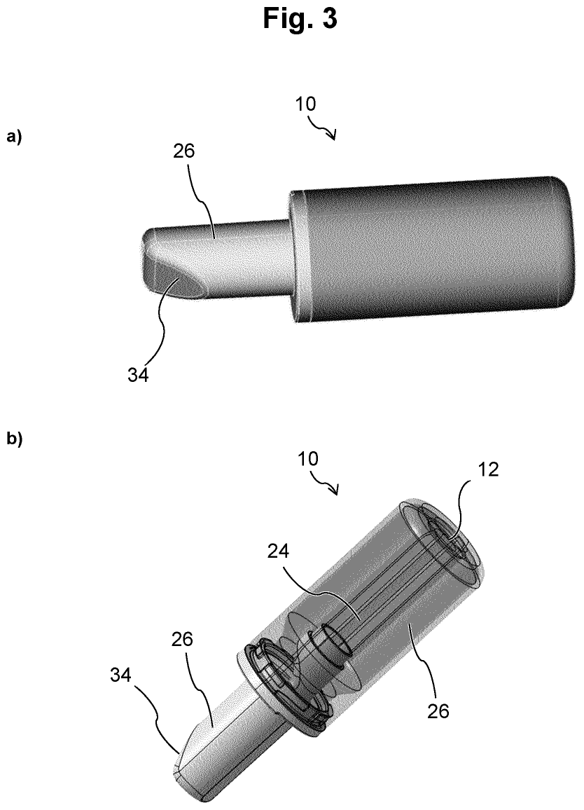

FIGS. 3a and 3b show cartridges for use with an aerosol-generating device; and

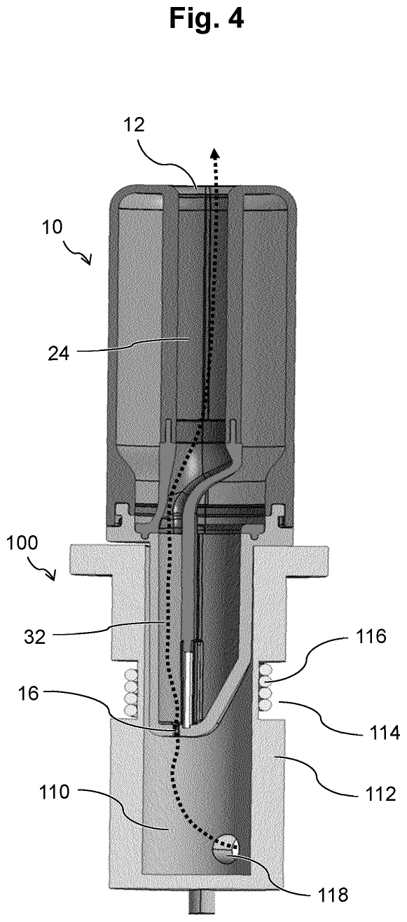

FIG. 4 shows an aerosol-generating system.

FIG. 1a shows a cartridge 10 for use with an aerosol-generating device in cross-sectional view. The cartridge 10 comprises an inner airflow channel extending between an air outlet 12 at a proximal end 14 and an air inlet 16 at a distal end 18 of the cartridge 10 along a longitudinal central axis 20 of the cartridge 10.

A proximal portion of the cartridge 10 comprises a liquid storage portion 22 for storing a liquid aerosol-forming substrate.

In the embodiment of FIGS. 1a to 1c, the liquid storage portion 22 is tubular and surrounds a proximal portion of the inner airflow channel 24. This shape and position of the liquid storage portion 22 is, however, not mandatory.

A distal portion of the cartridge 10 comprises an outer wall 26, a liquid supply channel 28 and an internal separating wall 30. The liquid supply channel 28 is in fluid communication with the liquid storage portion 22. The distal portion of the cartridge 10 is surrounded by the outer wall 26. In the embodiment of FIGS. 1a to 1c, the outer wall 26 of the distal portion of cartridge 10 is tubular. This is, however, not mandatory.

The separating wall 30 is arranged between the liquid supply channel 28 and a distal portion of the inner airflow channel 32. In the embodiment of FIGS. 1a to 1c, the separating wall 30 is arranged offset relative to the longitudinal central axis 20. This offset arrangement is, however, not mandatory.

A region of the outer wall 26 surrounding a distal part of the liquid supply channel 28 comprises an inclined wall portion 34 such that the distal part of the liquid supply channel 28 is narrower than a proximal part of the liquid supply channel 28. The inclined wall portion 34 is substantially planar. By the inclined outer wall portion 34, the outer wall tapers towards the distal end 18 of the cartridge 10. The inclined outer wall portion 34 is thus configured such that the outer shape of the cartridge 10 tapers towards distal end 18 of the cartridge 10.

A distal part of the separating wall 30 comprises a fluid permeable portion 36 to fluidly connect the narrower distal part of the liquid supply channel 28 with the distal portion of the inner airflow channel 32. Both the fluid permeable wall portion 36 and the inclined wall portion 34 may extend up to a distal end of the liquid supply channel 28 in a direction in parallel to the longitudinal central axis 20 as shown in the embodiment of FIG. 1a.

FIG. 1b shows a cross-section of FIG. 1a along line B-B at a longitudinal position where the fluid permeable wall portion 36 is already present, but proximal to the onset of the inclined wall portion 34, resulting in a circular cross-section. One or both of a susceptor element 38 and a wick element 40 may be arranged in the the fluid permeable wall portion 36. The susceptor element 38 and the wick element 40 may form part of a heater assembly.

FIG. 1c shows a cross-section of FIG. 1a along line C-C at a longitudinal position proximal to the fluid permeable wall portion 36 and proximal to the onset of the inclined wall portion 34, resulting in a circular cross-section. No fluid can pass through the separating wall 30 between the liquid supply channel 28 and the distal portion of the inner airflow channel 32 except for the longitudinal position where the fluid permeable wall portion 36 is provided.

FIG. 2a shows a distal portion of a cartridge 10 for use with an aerosol-generating device. The cartridge may be the same as the cartridge of FIGS. 1a to 1c. In the embodiment of FIG. 2a, an acute angle 21 between the longitudinal central axis 20 and a normal to the planar inclined wall portion 34 is between 60 degrees and 75 degrees, preferably between 66 degrees and 70 degrees. Other angles are possible.

FIG. 2b shows a cross-section of FIG. 2a along line B-B at a longitudinal position distal to the onset of the inclined wall portion 34, resulting in a non-circular cross-section. In comparison, FIG. 2c shows a cross-section of FIG. 2a along line C-C at a longitudinal position proximal to the onset of the inclined wall portion 34, resulting in a circular cross-section. Double-ended arrows in FIGS. 2b and 2c indicate that, due to the inclined wall portion 34, the distal part of the liquid supply channel 28 is narrower than a proximal part of the liquid supply channel 28.

FIG. 3a shows a cartridge 10 for use with an aerosol-generating device in perspective view. A region of the outer wall 26 surrounding a distal part of the liquid supply channel (not visible in FIG. 3a) comprises an inclined wall portion 34.

FIG. 3b shows a cartridge 10 for use with an aerosol-generating device in perspective view. A region of the outer wall 26 surrounding a distal part of the liquid supply channel (not visible in FIG. 3b) comprises an inclined wall portion 34. The proximal portion of the cartridge 10 of FIG. 3b comprises a tubular liquid storage portion 22 comprising transparent walls. The proximal portion of the inner airflow channel 24 extending from the air outlet 12 is visible through the transparent walls. Also, the transparent walls of the liquid storage portion 22 may allow for a user to visually verify the amount of liquid aerosol-forming substrate remaining in the cartridge 10. This is, however, not required and some or all of the walls may alternatively be semi-transparent or nontransparent.

FIG. 4 shows an aerosol-generating system in cross-sectional view. The aerosol-generating system comprises a cartridge 10 and an aerosol-generating device 100. Only part of the device 100 is shown in FIG. 4. The aerosol-generating device 100 comprises a cavity 110 for receiving a distal portion of the cartridge 10. A wall 112 of the cavity 110 comprises a recessed portion 114. The aerosol-generating device 100 comprises an inductor coil 116. The inductor coil 116 is provided at the recessed portion 114 and circumscribes the cavity 110. By means of the recessed portion 114, the inductor coil 116 may advantageously be located in closer proximity to the susceptor element 38 of the cartridge 10.

During use, an alternating current applied to the inductor coil 116 induces electric currents in the susceptor element 38 of the cartridge 10. As a consequence, the susceptor element 38 heats up. Heat is distributed to liquid aerosol-forming substrate within, or in close proximity to the susceptor element 38. In turn, said liquid aerosol-forming substrate evaporates. As shown by a dotted arrow in FIG. 4, ambient air may enter the device 100 via device air inlet 118. The air may then travel through cavity 110 to enter the distal portion of the inner airflow channel 32 via the air inlet 16 of the cartridge 10. The air may then take up the evaporated substrate which may further condense to form an aerosol on the way towards the air outlet 12 of the cartridge 10 via the proximal portion of the inner airflow channel 24. At the air outlet 12, the aerosol may be inhaled by a user.

1.-15. (canceled)

16. A cartridge for an aerosol-generating device, the cartridge comprising:
an inner airflow channel extending between a proximal end and a distal end of the cartridge along a longitudinal central axis of the cartridge;
a proximal portion of the cartridge comprising a liquid storage portion configured to store a liquid aerosol-forming substrate; and
a distal portion of the cartridge comprising an outer wall, a liquid supply channel, and an internal separating wall, the liquid supply channel being in fluid communication with the liquid storage portion, the separating wall being arranged between the liquid supply channel and a distal portion of the inner airflow channel, wherein the distal portion of the cartridge is surrounded by the outer wall,
wherein a region of the outer wall surrounding a distal part of the liquid supply channel comprises an inclined wall portion of the outer wall such that the distal part of the liquid supply channel is narrower than a proximal part of the liquid supply channel, and
wherein a distal part of the separating wall comprises a fluid permeable portion to fluidly connect the narrower distal part of the liquid supply channel with the distal portion of the inner airflow channel.

17. The cartridge according to claim 16,
wherein the fluid permeable portion of the separating wall extends up to a distal end of the liquid supply channel, and
wherein the inclined wall portion of the outer wall extends up to the distal end of the liquid supply channel.

18. The cartridge according to claim 16, wherein the inclined wall portion is substantially planar.

19. The cartridge according to claim 18, wherein an angle between the longitudinal central axis and a normal to the planar inclined wall portion is between 45 degrees and 85 degrees.

20. The cartridge according to claim 16, wherein the liquid storage portion surrounds a proximal portion of the inner airflow channel.

21. The cartridge according to claim 20, wherein the liquid storage portion comprises a tubular portion.

22. The cartridge according to claim 16, wherein the separating wall is substantially planar.

23. The cartridge according to claim 22, wherein the separating wall extends substantially in parallel to the longitudinal central axis of the cartridge.

24. The cartridge according to claim 16,
wherein the fluid permeable portion of the separating wall comprises a wick element, and
wherein the liquid supply channel is configured to supply liquid from the liquid storage portion to the wick element.

25. The cartridge according to claim 24, wherein the wick element is arranged on a first side of the separating wall facing the liquid supply channel.

26. The cartridge according to claim 24, wherein the wick element comprises one or more of a cotton-based material, a porous ceramic-based material, and a porous graphite-based material.

27. The cartridge according to claim 24,
wherein the distal portion of the cartridge further comprises a heater assembly configured to heat the liquid aerosol-forming substrate,
wherein the wick element of the fluid permeable portion of the separating wall forms part of the heater assembly, and
wherein the liquid supply channel is configured to supply liquid from the liquid storage portion to the heater assembly.

28. The cartridge according to claim 27, wherein the heater assembly comprises a susceptor element configured to heat the liquid aerosol-forming substrate.

29. The cartridge according to claim 28, wherein the susceptor element is arranged on a second side of the separating wall facing the distal portion of the inner airflow channel.

30. The cartridge according to claim 16, wherein the distal portion of the cartridge has a circular cross-section and the proximal portion of the cartridge has an oval cross-section.

31. The cartridge according to claim 30, wherein the oval cross-section tapers towards the proximal end.

32. The cartridge according to claim 16, wherein an outer diameter of the outer wall in a transverse direction does not exceed 10 millimeters, the transverse direction being perpendicular to the longitudinal central axis.

33. The cartridge according to claim 16, wherein the liquid supply channel comprises an adsorbent material.

34. The cartridge according to claim 16, wherein one or both of:
the outer wall of the distal portion of the cartridge is substantially tubular, and
the proximal portion of the cartridge is configured as a mouthpiece.

35. An aerosol-generating system, comprising:
the cartridge according to claim 16; and
an aerosol-generating device comprising a cavity arranged to receive at least the distal portion of the cartridge and an inductor coil at least partly surrounding the cavity.
